(19) United States
(12) Patent Application Publication
(10) Pub. No.: US 2007/0082087 A1
(43) Pub. Date: Apr. 12, 2007

(54) Fermented milk products containing bifidobacterium longum and isomalto oligosaccharide and the process for producing the same

(75) Inventors: Tsun-Yung Kuo, I-Lan (TW); Gabriel Hsu-Chung Chen, Taipei (TW)

Correspondence Address: HDSL, 4331 STEVENS BATTLE LANE, FAIRFAX, VA, 22033, US

(73) Assignee: Schweitzer Biotech Company Ltd.

(21) Appl. No.: 11/243,988

(22) Filed: Oct. 6, 2005

(51) Int. Cl. A23C 9/12

(52) U.S. Cl. 426/43

(57) ABSTRACT

A fermented milk product containing Bifidobacterium longum and isomalto oligosaccharide is fermented by Bifidobacterium longum, Lactobacillus delbrueckii subsp. Bulgaricus, and Streptococcus thermophilus, and added isomalto oligosaccharide to promote the growth Bifidobacterium longum and to be the sweetener of the product. The process for producing the fermented milk product comprises adding isomalto oligosaccharide into milk, after mixing the isomalto oligosaccharide and the milk, inoculating the resulting mixture with Bifidobacterium longum as the main fermenting agent, together with Lactobacillus delbrueckii subsp. Bulgaricus and Streptococcus thermophilus, and then carrying out filling, fermenting, and ripening to obtained the fermented milk product of the invention.

### BACKGROUND OF THE INVENTION

1. Field of the Invention

The invention relates to fermented milk products containing Bifidobacterium longum and isomalto oligosaccharide and the processes for producing the same. In particularly, the fermented milk products are fermented by Bifidobacterium longum as the fermentation agent, together with Lactobacillus delbrueckii subsp. Bulgaricus and Streptococcus thermophilus, without adding any sugars such as sucrose, dextrose, meliose, maltose, fructose and other sugars but using isomalto oligosaccharide as the growth-promoting substance of Bifidobacterium longum and as the sweetener of the fermented milk products and using the lactose in the milk as the growth-promoting substance of Lactobacillus delbrueckii subsp. Bulgaricus and Streptococcus thermophilus

2. Description of the Prior Art

In recent years, the benefit of intestinal microflora for human health has become more and more valued. A number of probiotics isolated from human body have been used in dairy products. For example, probiotics such as Bifidobacterium sp. and Lactobacillus sp. have been used extensively for producing fermented milk products. Among them, the benefit of Bifidobacterium sp. to the health situation of the intestine as well as the application of Bifidobacterium sp. for the production of fermented milk products has been the focus of interest.

Bifidobacterium longum is an anaerobic, non-motile, branched rod-shaped, non-spore forming, Gram-positive bacillus. Numerous studies in recent years indicate that Bifidobacterium longum gives physiological effects far more beneficial to humans than that of lactococcus and streptococcus bacillus. The main effects on human body of Bifidobacterium longum include:

(1) Controls intestinal pH by liberating lactic acid and acetic acid which also decreases the pH and inhibits the growth of pathogenic bacteria such as but not limited to Candida albicans and E. coli.

(2) Suppresses putrefactive bacteria.

(3) Inhibits the production of toxic amines.

(4) Decreases the course of erythromucin-induced diarrhea (Colombel J. F. et al., 1987, Yoghurt with Bifidobacterium longum reduces erythromycin-induced gastrointestinal effects, Lancet, 2:43).

(5) Improves lactose digestion and alleviates symptoms of lactose intolerance (Jiang. et al., 1996, Improvement of lactose digestion in humans by ingestion of unfermented milk containing Bifidobacterium longum, J. Dairy Sci., 79:750-57.).

(6) Reduces risk of colon cancer (Reddy, B. S., 1999, Possible mechanisms by which pro- and prebiotics influence colon carcinogenesis and tumor growth, J. Nutr. 129: 1478-82S.)

(7) Improves serum lipid (Mann, G. V. and A. Spoerry, 1974, Studies of a surfactant and cholesterolemia in the Massai, Am. J. Clin. Nutr. 27: 464-69; Xiao, J. Z. et al., 2003, Effects of milk products fermented by Bifidobacterium longum on blood lipids in rats and healthy adult male volunteers, J. Dairy Sci., 86: 2452-61.).

(8) Synthesizes vitamin B₁, B₂, B₆, and B₁₂ as well as amino acids such as alanine, valine, aspartic acid and threonine.

Bifidobacteria are normal inhabitants of the human and animal colon. Bifidobacterium longum is present in the intestinal tract of an infant up to 3 or 4 months after birth. The population of Bifidobacterium longum in the intestinal tract of a child increases progressively to about 25% of the total bacteria. However, with advanced age, the population of Bifidobacterium longum in the intestinal tract declines year by year, while the population of the pathogenic bacteria, such as Bacteroides, Eubacteria, Poptostreptococcacrae, Clostridia and the like, in the intestinal tract increase significantly.

Therefore, increasing the population of the Bifidobacterium in the intestinal tract has been the interest of many health food industrials. There are two ways for increasing an advantageous number of Bifidobacterium in the intestinal tract. One way is supplementation with products containing live Bifidobacterium. The other way is taking food ingredients that may beneficially affect the host by selectively stimulating the growth and/or the activity of Bifidobacterium, such as isomalto oligosaccharide.

Fermented milk products containing Bifidobacterium commercially available nowadays are mainly fermented by Lactobacillus and Streptococcus bacteria, and then added some Bifidobacterium longum or infantis or the same in coated and protected manner, to supplement a number of Bifidobacterium for the consumer. For example, Yoplait® Living Bacteria Sphere Low-fat Active yogurt, Drinking Yogurt® of Kuang Chuan Dairy Co. Ltd., Taiwan and yogurt of Weichuan LinPhoneIng Co., Ltd., Taiwan, these fermented products all fermented by Lactobacillus delbrueckii bulgaricus and Streptococcus thermophilus. After accomplishing the fermentation, Bifidobacterium longum is added in the fermented products, followed by filling and packaging to obtain the final products.

Nevertheless, the population of Bifidobacterium of the foregoing fermented milk products produced by adding externally Bifidobacterium is only up to 10⁶ cfu/ml, the level of functional activity of Bifidobacterium. For example, Yoplait® Living Bacteria Sphere Low-fat Active yogurt contains 1.6×10⁶ cfu/ml of Bifidobacterium, Drinking Yogurt® of Kuang Chuan Dairy Co. Ltd. contains 1×10⁶ cfu/ml of Bifidobacterium, and the yogurt product of Weichuan LinPhoneIng Co., Ltd. contains 1×10⁸cfu/ml of total lactic acid bacteria (including Streptococcus thermophilus, Lactobacillus delbrueckii subsp. Bulgaricus, Lactobacillus acidophilus, and Bifidobacterium). As a result, these products have a limited effect for supplementing Bifidobacterium in a human intestinal tract, and are restricted on supplementing Bifidobacterium through adding externally, while is unable to achieve the effect of promoting in vivo amplification of Bifidobacterium due to the lack of isomalto oligosaccharide.

Besides, most of the foregoing commercially available fermented milk products containing Bifidobacterium have been added with sucrose, refined sugar dextrose, maltose, fructose or other sugars except isomalto oligosaccharide, as the bacteria nutrient and as sweetener. For example, Yoplait® Living Bacteria Sphere Low-fat Active yogurt has been added with refined sugar and 55% of fructose, Drinking Yogurt® of Kuang Chuan Dairy Co. Ltd. has been added with a high level of fructose syrup and refined sugar, and the yogurt product of Weichuan LinPhoneIng Co., Ltd. Has been added sucrose. However, refined sugar causes dental caries to children, and is not suitable for the diabetics to consume. Further, though the fermented dairy product with added fructose are not subject to the above-described dental caries as sucrose or diabetes mellitus to that extent, the fructose is still a source of high energy to be concerned by the obese or calorie conscious consumer.

Accordingly, the conventional fermented milk products containing lactic acid bacteria exhibits still many disadvantages and is not a perfect design and needs improvement to be a healthy product.

In view of the foregoing disadvantages derived from the foregoing fermented milk products, the inventors have devoted to improve and innovate it, and after studying intensively for a number of years, have developed successfully fermented milk products containing Lactobacillus delbrueckii subsp. Bulgaricus, Streptococcus thermophilus and Bifidobacterium longum and isomalto oligosaccharide and a process for producing the same according to the invention.

### SUMMARY OF THE INVENTION

The invention provides fermented milk products fermented by Bifidobacterium longum, Lactobacillus delbrueckii subsp. Bulgaricus, and Streptococcus thermophilus, and added isomalto oligosaccharide to increase the population of Bifidobacterium longum in the fermented milk products according to the invention.

Furthermore the invention provides a method to acclimatize the anaerobic Bifidobacterium longum to gradually accept aerobic fermentation and a method to acclimatize Bifidobacterium longum to tolerate lower pH levels than would be normal such as to bypass the stomach in larger than normally expected numbers and to be delivered into the intestinal tract.

Furthermore, the invention provides a fermented milk product containing isomalto oligosaccharide as the Bificus-factor that can activate Bifidobacterium longum in the human intestinal tract to improve its growth and amplification so as to increase the population of Bifidobacterium longum in the intestinal tract through dual ways of adding externally and growing in vivo.

The invention provides fermented milk products without adding sucrose, dextrose, maltose, fructose and other sugars except using isomalto oligosaccharide as the nutrient of Bifidobacterium longum and the sweetener of the fermented milk products. Since no sugars are added, the fermented milk products contribute to reduce dental caries, and are suitable for diabetics. And since no sucrose, dextrose, meliose, maltose, fructose and other sugars are added, there is reduced concern about weight gain due to high caloric content.

The fermented milk products containing Bifidobacterium longum and isomalto oligosaccharide can achieve the above-described objectives of the invention. It comprises adding isomalto oligosaccharide in milk, milk powder, skim milk with or without whey, without adding any sucrose, dextrose, meliose, maltose, fructose and other sugars.

After mixing, the mixture is inoculated with Lactobacillus delbrueckii subsp. Bulgaricus, Streptococcus thermophilus and Bifidobacterium longum as the fermenting agents, and then fermentation is carried out, later on cured and cooled to obtain the fermented milk products.

These features and advantages of the present invention will be fully understood and appreciated from the following detailed description of the accompanying Drawings.

### BRIEF DESCRIPTION OF THE DRAWINGS

FIG. 1 is a flow chart showing the production of the fermented milk product containing Lactobacillus delbrueckii subsp. Bulgaricus, Streptococcus thermophilus and Bifidobacterium longum and isomalto oligosaccharide according to the invention.

### DETAILED DESCRIPTION OF THE PREFERRED EMBODIMENT

### Example 1

### Acclimatization of Bifidobacterium longum

The Bifidobacterium longum in this invention has been isolated from the human infant, and has been kept isolated at the laboratory of the inventor.

The anaerobic Bifidbacterium longum bacteria has been cultured trough a number of sequences to acclimatize to tolerate aerobic conditions, by gradually exposing the Bifidobacterium longum to oxygen at minute levels, thereby selecting for strains with the better tolerance for aerobic conditions and at the same time not reducing its ability to yield acetic and lactic acid.

The Bifidobacterium longum was in parallel exposed to minute but gradual reduction in pH environment thereby over numerous passages selection of lower pH tolerant strains was isolated and selected for continued lowering pH tolerance.

The acclimatization of the Bifidobacterium longum has enabled the Bifidobacterium longum that is added in the fermented milk to be produced in larger numbers in the milk fermentation direct, as well as enable a larger number of Bifidobacterium longum to bypass the stomach and into the intestines where they will multiply rapidly with the help of the isomalto oligosaccharide.

### Example 2

Producing the fermented milk products containing Bifidobacterium longum and isomalto oligosaccharide

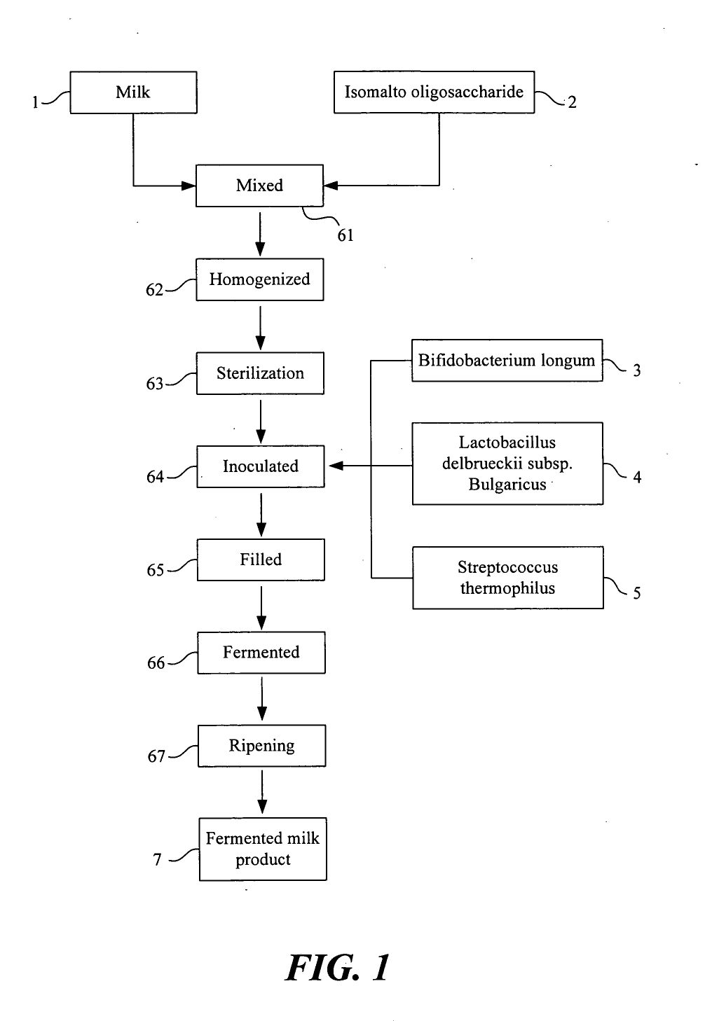

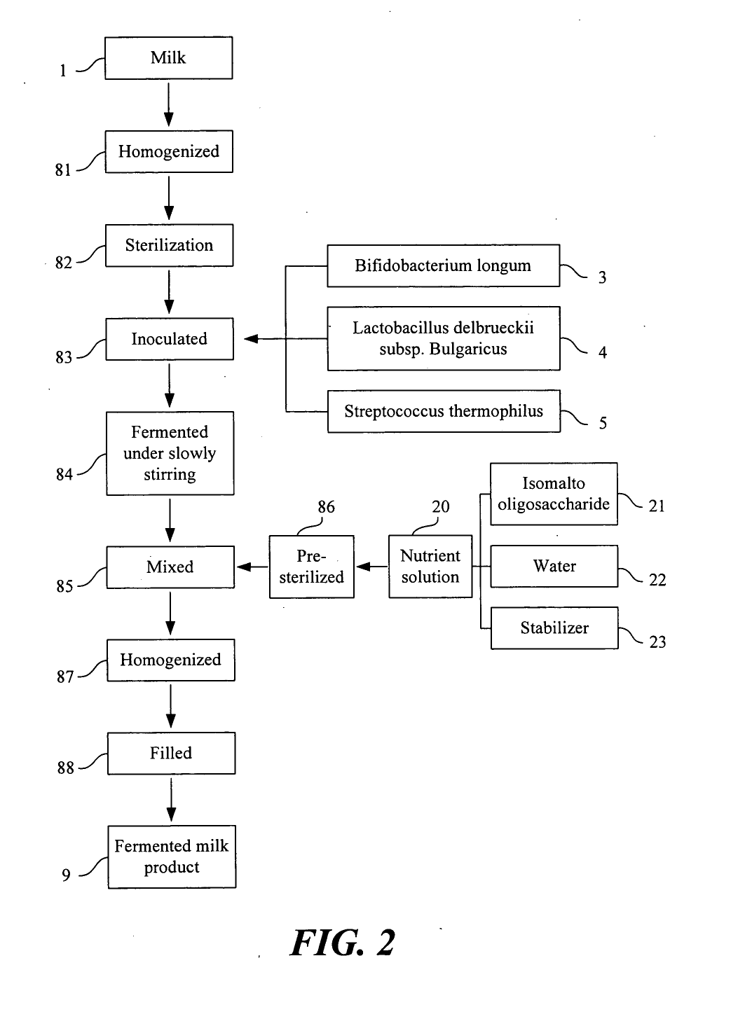

Referring to FIG. 1, the fermented milk products containing Bifidobacterium longum and isomalto oligosaccharide and the process for producing the same provided by the invention comprises mainly:

Milk with or without whey 1, the milk is whole milk, raw milk, skim milk, reconstituted milk or milk powder;

Isomalto oligosaccharide 2 sugars including isomaltose, panose, isomaltotriose and maltose without any other sugars;

Bifidobacterium longum 3;

Lactobacillus delbrueckii subsp. Bulgaricus 4; and

Streptococcus thermophilus 5.

Isomalto oligosaccharide 2 without other sugars was added in the milk 1. The mixture of the milk 1 and the Isomalto ologosaccaride 2 was mixed 61, homogenized 62 and subjected to sterilization 63 by a ultrahigh temperature instant sterilization method (UHT sterilization method, under conditions of 135-145° C., 0.5-5 seconds. The UHT step is however not necessary where UHT treatment of dairy products in many parts of the world is not a requirement.) Thereafter, the mixture is cooled to room temperature and was inoculated 64 with Bifidobacterium longum 3, Lactobacillus delbrueckii subsp. Bulgaricus 4 and Streptococcus thermophilus 5. The resulting mixture was filled 65, and fermented 66 for more than 2 hours, and then stored under cooling (2-8° C.) more than 10 hours for ripening 67. The fermented milk products 7 contain Bifidobacterium longum and isomalto oligosaccharide according to the invention was thus obtained.

### Example 3

Producing the fermented milk products containing Bifidobacterium longum and isomalto oligosaccharide

Referring to FIG. 2, the fermented milk products containing Bifidobacterium longum and isomalto oligosaccharide and the process for producing the same provided by the invention comprises mainly:

Milk with or without whey 1, the milk is whole milk, raw milk, skim milk, reconstituted milk or milk powder;

Nutrient solution 20 comprised of water 22, isomalto oligosaccharide 21 and stabilizer 23;

The isomalto oligosaccharide 21 including isomaltose, panose, isomaltotriose and maltose without any other sugars;

Bifidobacterium longum 3;

Lactobacillus delbrueckii subsp. Bulgaricus 4; and

Streptococcus thermophilus 5.

Milk with or without whey 1 is homogenized 81 then subjected to sterilization 82 by an ultrahigh temperature instant sterilization method (UHT sterilization method, under conditions of 135-145° C., 0.5-5 seconds. The UHT step is however not necessary where UHT treatment of dairy products is not a requirement.). The milk 1 is cooled to approximately 50° C. then inoculated 83 with Bifidobacterium longum 3, Lactobacillus delbrueckii subsp. Bulgaricus 4, and Streptococcus thermophilus 5. And then fermented under slowly stirring 84 for approximately 3 hours. The fermented milk is then mixed 85 with the nutrient solution 20 comprised of water 22, isomalto oligosaccharide 21 and stabilizer 23 that has been pre-sterilized 86 at 90-95° C. between 5 and 10 minutes, then cooled to approximately 50° C. The mixture is then homogenized 87. Thereafter, the fermented milk is filled 88 into finished product 9 packing without requirement for specific post fermentation or ripening. The fermented milk product 9 contains Bifidobacterium longum 3 and isomalto oligosaccharide 21 according to the invention was thus obtained.

The fermented milk products containing Bifidobacterium longum and isomalto oligosaccharide according to the invention utilizes Bifidobacterium longum as the main fermenting agent to the invention, and can as shown perform fermentation together with other bacteria. The other bacteria are not limited to the above-mentioned Lactobacillus delbrueckii subsp. Bulgaricus and Streptococcus thermophilus, and can also include Streptococcus lactis, Lactobacillus acidophilus, Lactobactillus bifidus, Lactobacillus rhamnosus, Lactobacillus casei, Lactobacillus causasicus, Bifidobacterium lactis, Bifidobacterium infantis or Lactobacillus paracasei, or may be selected from the group consisting of Lactobacillus, Leuconostoc, Streptococcus, Pediococcus, Sporolactobacillus, Enterococcus, Lactococcus, Camobacterium, Vagococcus, Tetragenococcus, Bifidobacterium, Atopobium, Weissella, Abiotrophia, Granulicatella, Oenococcus and Paralactobacillus.

Table 1 shows the comparison of the fermented milk product according to the invention with some other commercial fermented milk products. Since the fermented milk product of the invention contains isomalto oligosaccharide to promote the growth of Bifidobacterium longum, the number of live Bifidobacterium longum in the fermented milk product of the invention is up to 9×10⁸−4×10⁹ cfu/ml or even higher. Furthermore, the fermented milk product of the invention is present in a milk gel like state, which favors the storage of Bifidobacterium longum. There was more than 10⁷ cfu/ml live Bifidobacterium longum after storing for two weeks.

Since the fermented milk products of the invention comprises isomalto oligosaccharide to promote the growth of Bifidobacterium longum, not only the growth of Bifidobacterium longum in the fermented milk products can be promoted, but also owing to pH resistance and heat resistance exhibited by the isomalto oligosaccharide, it could not be utilized by the human intestinal pathogenic bacteria, such that, after eating, the product of the invention can pass the stomach and small intestine without its molecular structure being destroyed by gastric acid, bile juice, and pancreatic juice, and can arrive directly in the large intestine to be utilized by the endogenous Bifidobacterium longum. Thus to achieve the purpose of increasing the number of Bifidobacterium longum in the intestinal tract through dual ways: external addition via the fermented milk products and in vivo growth promotion.

Accordingly, the invention fermented milk products containing Bifidobacterium longum and isomalto oligosaccharide can supplement the amount of Bifidobacterium longum in the intestine of the consumer, enabling the physiological effects of Bifidobacterium longum for the consumer, treats intestinal disorders, prevents constipation and diarrhea, promotes absorption of nutritional substances through synthesizing essential nutrients such as vitamin B1, B2, B6, B12 and alanine, valine, aspartic acid and threonine. Furthermore, since no sugars such as sucrose, dextrose, fructose, meliose and other sugars and artificial sweeteners are added in the fermented milk products of the invention, the sweetness of the product is provided by the isomalto oligosaccharide, the inventive product can thus reduce dental caries, and owing to its low caloric value as well as low intestinal absorption, no obesity concern exists, and can be taken by diabetics.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A process for producing fermented milk products containing Bifidobacterium longum and isomalto oligosaccharide, comprising steps of:
step 1: adding isomalto oligosaccharide and/or other carbohydrate in milk;
step 2: mixing the milk and the isomalto oligosaccharide;
step 3: inoculating Bifidobacterium longum as the main fermenting agent to the invention in the product obtained in step 2, and then inoculating other lactic acid bacteria; and
step 4: carrying out filling, fermentation, and ripening to obtain the fermented milk products containing Bifidobacterium longum and isomalto oligosaccharide.

2. A process for producing a fermented milk product containing Bifidobacterium longum and isomalto oligosaccharide according to claim 1, wherein the milk is with or without whey, the milk is whole milk, raw milk, skim milk, reconstituted milk or milk powder.

3. A process for producing a fermented milk product containing Bifidobacterium longum and isomalto oligosaccharide according to claim 1, wherein the other lactic acid bacterium is Lactobacillus delbrueckii subsp. Bulgaricus.

4. A process for producing a fermented milk product containing Bifidobacterium longum and isomalto oligosaccharide according to claim 1, wherein the other lactic acid bacterium is Streptococcus thermophilus.

5. A process for producing a fermented milk product containing Bifidobacterium longum and isomalto oligosaccharide according to claim 1, wherein the other lactic acid bacteria are Lactobacillus delbrueckii subsp. Bulgaricus and Streptococcus thermophilus.

6. A process for producing a fermented milk product containing Bifidobacterium longum and isomalto oligosaccharide according to claim 1, wherein the other lactic acid bacteria are selected from the group consisting of Lactobacillus, Leuconostoc, Streptococcus, Pediococcus, Sporolactobacillus, Enterococcus, Lactococcus, Carnobacterium, Vagococcus, Tetragenococcus, Bifidobacterium, Atopobium, Weissella, Abiotrophia, Granulicatella, Oenococcus, and Paralactobacillus.

7. A process for producing fermented milk products containing Bifidobacterium longum and isomalto oligosaccharide according to claim 1, wherein said Bifidobacterium longum is acclimatized to tolerate aerobic conditions and to tolerate low pH.

8. A process for producing fermented milk products containing Bifidobacterium longum and isomalto oligosaccharide according to claim 1, wherein said isomalto oligosaccharide comprises isomaltose, panose, isomaltotriose and maltose.

9. A process for producing fermented milk products containing Bifidobacterium longum and isomalto oligosaccharide according to claim 1, wherein said carbohydrate comprises glucose, fructose, galactose, sucrose, maltose, lactose, maltodextrins, corn syrup, high-fructose corn syrup, and oligosaccharide.

10. Fermented milk products containing Bifidobacterium longum and isomalto oligosaccharide obtained using the process according to claim 1.
